(19) United States
(12) Patent Application Publication
(10) Pub. No.: US 2026/0134176 A1
(43) Pub. Date: May 14, 2026

(54) METHOD FOR DYNAMIC MODELING OF POWER SYSTEM COMPONENT BASED ON MULTI-GATE MIXTURE-OF-EXPERTS (MMOE)-DIFFERENTIAL-ALGEBRAIC EQUATION (DAE) MODEL

(71) Applicant: Sichuan University, Chengdu City (CN)

(72) Inventors: Shilin Gao, Chengdu City (CN); Zongsheng Zheng, Chengdu City (CN); Yuhong Wang, Chengdu City (CN); Xu Zhou, Chengdu City (CN); Jianquan Liao, Chengdu City (CN); Yushan Yin, Chengdu City (CN); Yifei Wang, Chengdu City (CN)

(21) Appl. No.: 19/385,865

(22) Filed: Nov. 11, 2025

(30) Foreign Application Priority Data
Nov. 12, 2024 (CN) 202411611344.6

(51) Int. Cl. G06F 30/27; G06F 111/10; G06F 119/06; G06N 3/045; G06N 3/048

(52) U.S. Cl. CPC G06F 30/27; G06N 3/045; G06N 3/048; G06F 2111/10; G06F 2119/06

(57) ABSTRACT

Provided is a method for dynamic modeling of a power system component based on a multi-gate mixture-of-experts (MMoE)-differential-algebraic equation (DAE) model, which belongs to the technical field of electric digital data processing. High-precision and three-phase unified modeling is achieved for a dynamic component of a power system. The MMoE-DAE model can achieve precise modeling of a complex high-order dynamic component in the power system even in the absence of a detailed physical model. A neural ordinary differential equation (ODE) and an automatic order upgrading mechanism are integrated, which effectively enhances a modeling capability for a dynamic behavior of a complex component under various disturbance scenarios, and ensures high precision and robustness even under a strong nonlinear and high-order dynamic condition.

### CROSS REFERENCE TO RELATED APPLICATION

This patent application claims the benefit and priority of Chinese Patent Application No. 2024116113446, filed with the China National Intellectual Property Administration on Nov. 12, 2024, the disclosure of which is incorporated by reference herein in its entirety as part of the present application.

### TECHNICAL FIELD

The present disclosure relates to the field of electric digital data processing, and specifically, to a method for dynamic modeling of a power system component based on a multi-gate mixture-of-experts (MMoE)-differential-algebraic equation (DAE) model.

### BACKGROUND

Due to large-scale integration of power electronic devices, a power system exhibits complex dynamics, creating an urgent need to develop a highly reliable dynamic equivalent model using limited component measurement data. Electromagnetic transient (EMT) simulation, which is based on an instantaneous state of a system, can describe a microsecond-level process involving a switching device and is crucial for precise stability analysis and control of a modern power system. Traditional EMT simulation relies on detailed physical models (such as a differential equation and an algebraic equation) of a component, typically requiring precise physical parameters and operating conditions. However, in a practical power system, due to technical confidentiality, measurement limitations, or component complexity, physical models of some components may not be fully obtained, resulting in a so-called “black-box” or “gray-box” model. This makes it difficult for traditional modeling methods to provide reliable dynamic prediction. Integrating artificial intelligence technologies, particularly deep learning, with the EMT simulation is a current research hotspot, but this approach still faces many bottlenecks and challenges. Firstly, a system measurement device can only capture low-dimensional discrete data samples of limited frequencies, causing a traditional neural network model to perform well under known conditions but poorly in dynamic performance under unknown operating conditions. Secondly, it remains unclear whether a data-driven model can fully utilize historical data and adaptively adjust parameters based on system operating conditions to improve robustness and reliability of a simulation model. Furthermore, although some studies have combined physical characteristics of the power system with the deep learning, existing models still need to be improved in their capabilities of handling high-order differential dynamics and adapting to diverse scenarios. Finally, despite significant progress in data-driven modeling, it is still relatively rare to integrate a deep learning model into commercially operated EMT simulation for unified simulation.

With large-scale integration of renewable energy and power electronic loads, a large-scale power system exhibits increasingly complex nonlinear dynamics and coupling characteristics, imposing higher requirements for the precise stability analysis and control of the modern power system. However, in the absence of apriori knowledge, due to technical protection and measurement limitations, a system access device often has the black-box or gray-box model, where unmodeled components significantly undermine reliability of a system operation decision made by a carrier. Additionally, even with a comprehensive white-box model, achieving a high-order dynamic response in a large-scale system within acceptable time and limited computational resources remains a major challenge. Therefore, dynamic modeling needs to be performed on a black-box component, and the EMT simulation is adopted for computation and analysis.

Existing dynamic modeling techniques for the EMT simulation face many problems when dealing with dynamic behaviors of complex components in the modern power system. Firstly, there is a lack of a physical model. Due to the technical confidentiality, the measurement limitations, and the system component complexity, many power system components lack a detailed internal model (such as the “black-box” or “gray-box” model), making it difficult for the traditional EMT simulation to provide accurate dynamic prediction without complete physical description, thereby reducing simulation precision and robustness of the system. Secondly, although deep learning technologies hold broad application prospects in simulation, they highly depend on high-quality measurement data. However, a measurement device in the power system can typically only collect low-dimensional discrete data samples of limited frequencies. This makes it difficult for a deep learning model developed based on these data to generate a reliable, continuous, and accurate dynamic equivalent model. Thirdly, there is a lack of an adaptive capability. The existing deep learning model performs well under a known training dataset but cannot adaptively adjust its dynamic characteristics when facing an unseen operating condition or fault, resulting in poor simulation performance in a complex and variable scenario. Fourthly, a traditional deep learning model has a limited capability to capture high-order dynamic characteristics. When dealing with strong coupling and nonlinear disturbances in the system, the traditional deep learning model is difficult to maintain high dynamic tracking precision, and performs unstably in the case of severe disturbances in the large-scale power system. Fifthly, it is exceedingly rare to integrate the deep learning model into an existing commercial EMT simulation platform for unified simulation. A main reason is a lack of an effective data interface in the prior art, making it difficult to achieve seamless connection between the deep learning model and a traditional simulation platform, thereby limiting application of these technologies in practical engineering.

Therefore, there is a current need to design a method and system for dynamic modeling of a power system component based on an MMoE-DAE model, and a storage medium to address the above problems.

### SUMMARY

An objective of the present disclosure is to provide a method and system for dynamic modeling of a power system component based on an MMoE-DAE model, and a storage medium to address the existing technical problems in the prior art.

To achieve the above objective, the present disclosure adopts the following technical solutions:

A method for dynamic modeling of a power system component based on an MMoE-DAE model includes following steps:
S1: proposing an MMoE-DAE network, simulating a dynamic characteristic of a three-phase circuit by using a plurality of gated neural DAEs, and establishing a relationship between phases;
S2: proposing an automatic order upgrading module, and adopting a plurality of independent continuous numerical integration channels and a relevant state variable memory to automatically infer an optimal order for dynamic component modeling through a fully gated network; and
S3: accurately simulating, by the MMoE-DAE model, a dynamic relationship between the phases within a same model, to achieve unified modeling of the three-phase circuit and compensate for a shortcoming of a traditional model in processing a coupling relationship between the phases; and seamlessly integrating the MMoE-DAE model into an EMT simulation platform, and enabling real-time simulation and dynamic analysis in a practical industrial application scenario, thereby enhancing practicality and reliability of EMT simulation in a power system.

Further, in the step S1:
an architecture of the MMoE-DAE network for three-phase circuit modeling of a dynamic component includes four parts: an input part, a bottom model, a tower model, and a gating network module;
the input part receives historical current signals i_{A}(t), i_{B}(t), i_{C}(t) of circuits of the phases, historical voltage signals u_{A}(t), u_{B}(t), u_{C}(t) of the circuits of the phases, and an external signal; and the historical current signals, the historical voltage signals, and the external signal are transmitted to an underlying neural-ordinary differential equation (ODE) expert module through a gating network to predict current and voltage changes at a next time step;
the bottom model includes a plurality of neural-ODE expert modules, where each of the plurality of neural-ODE expert modules is responsible for processing a different dynamic characteristic and scheduled by the gating network to determine which modules participate in a current modeling task; the plurality of neural-ODE expert modules are configured to approximate a differential equation of the dynamic component and model a relationship between current and voltage changes of the circuits of the phases and time; and the input signals i_{A}(t), i_{B}(t), i_{C}(t) are processed by a neural ODE to obtain currents i_{A}(t+1), i_{B}(t+1), i_{C}(t+1) of the circuits of the phases at the next time step;
the gating network module is responsible for selecting and scheduling the plurality of neural-ODE expert modules, choosing an appropriate neural-ODE expert for the current modeling task based on characteristics of the input signals, performing weight allocation through a softmax function, and scheduling the neural-ODE expert to participate in the modeling, where an output of the gating network module is transferred to a corresponding DAE tower based on states of the circuits of the phases; and
the tower model is divided into a plurality of DAE towers, and each of the plurality of DAE towers is configured to process a current of a corresponding phase in the three-phase circuit, namely the i_{A}(t+1), i_{B}(t+1), i_{C}(t+1); and based on the plurality of DAE towers, the MMoE-DAE model is capable of simultaneously processing multi-task modeling of the three-phase circuit and establishing an interrelationship between currents of the phases.

Further, in the step S2, the automatic order upgrading module is configured to:
automatically infer an optimal dynamic order of a component through the plurality of independent continuous numerical integration channel to enable the neural-ODE expert to process a high-order dynamic behavior, such that the MMoE-DAE model is still capable of dynamically adjusting a modeling order based on data for a component lacking detailed physical information, thereby ensuring modeling precision;
the automatic order upgrading module processes dynamic behaviors of different orders through the plurality of independent continuous numerical integration channels and automatically selects an optimal output through the gating network and a backward Euler method;
a multi-channel integration module has a plurality of independent integration channels, where each of the plurality of independent integration channels is configured to process a derivative of an order, and performs numerical integration based on a previous state to calculate a derivative value of the order; a first-order channel calculates a change rate of a system state, namely a derivative, to predict a change of the system state at the next time step; a second-order channel processes a first derivative and a second derivative, and calculates an acceleration or a higher-order change of the power system through state space transformation; and a third-order channel processes a higher-order change rate to capture a high-order dynamic behavior in a complex system;
a state storage unit is further introduced in the automatic order upgrading module to store state information calculated by each of the plurality of independent continuous numerical integration channels, such that the system is capable of accessing a previous state and derivative value when performing a plurality of integration operations, thereby guaranteeing continuity and accuracy of each of the plurality of independent continuous numerical integration channels; and
the gating network is configured to select a best order output from outputs of the plurality of independent continuous numerical integration channels, and a channel whose output is most appropriate is determined by using a trainable weight matrix W_{go} and the softmax function, where:
a principle of a multi-channel backward Euler upgrading module with dynamic component order identification is as follows:
an input initial state h₀, the first derivative h₀′, and the second derivative h₀″ undergo backward Euler upgrading to obtain first-order, second-order, and third-order predicted values;
and the backward Euler method performs numerical integration on a derivative of each order, thereby deriving a state change at each time step and ultimately obtaining a state at the next time step.

Further, the step S3 is as follows:
replacing, by the EMT simulation, each component with a Norton equivalent circuit, and constructing a network equation based on the equivalent circuit, thereby avoiding analyzing all DAEs of the system as discrete entities; and
a component simulation interface performs following four steps:
(1) calculating a state variable x(t+Δt)
inferring the state variable x(t+Δt) based on measured values î(t), û(t) and \hat{z}(t) of a component port, and calculating the x(t+Δt) by using a trapezoidal integration method:

$$x ( t + Δ t ) = x ( t ) + \frac{Δ t}{2} ( {ξ}_{ODE} ( x ( t ) ) + {ξ}_{ODE} ( x ( t + Δ t ) ) )$$

where a variable x(t) represents an implicit function of a port measurement value, which is constructed by an ODE expert neuron, namely x(t)=Γ(x(t−Δt), î(t),û(t),\hat{z}(t),t);
(2) deriving a Norton equivalent current i(t+Δt) of the component where following formulas are used:

$$\{ \begin{matrix}\dot{x} = f ( x , y , u ) \\ i = g ( x , y , u )\end{matrix}$$

where i represents a component injection current, and g(⋅) represents an algebraic equation (AE) describing a component current; and an AE tower module is used to calculate a port current of the dynamic component:

$$i ( t + Δ t ) = {Φ}_{ae} ( x ( t + Δ t ) , \hat{ι} ( t ) , \hat{u} ( t ) , \hat{z} ( t ) )$$

the steps (1) and (2) are executed entirely within the MMoE-DAE network, and a function of the MMoE-DAE network is consistent with an external characteristic of a general component;
(3) calculating a voltage vector V(t+Δt): combining a current I_{egl}(t+Δt) of a data-driven model component and a current I_{gen}(t+Δt) of the general component based on a node connection relationship to obtain that:

$$I ( t + Δ t ) = [ {I}_{eql} ( t + Δ t ) + {I}_{gen} ( t + Δ t ) ]$$

substituting a combined current into a formula GV=I to obtain that:

$$GV ( t + Δ t ) = I ( t + Δ t )$$

(4) calculating a branch current Iᵢⱼ(t+Δt): calculating the Iᵢⱼ(t+Δt) based on the V(t+Δt) and corresponding admittance Gᵢⱼ, in order to complete a historical current iteration process for the general component:

$${I}_{ij} ( t + Δ t ) = {G}_{ij} ( {V}_{i} ( t + Δ t ) - {V}_{j} ( t + Δ t ) ) .$$

A system for dynamic modeling of a power system component based on an MMoE-DAE model uses the above method for dynamic modeling of a power system component based on an MMoE-DAE model to perform dynamic modeling for the power system component.

A storage medium stores a computer program, and the computer program is executed to implement the above method for dynamic modeling of a power system component based on an MMOE-DAE model.

Compared with the prior art, the present disclosure has the following beneficial effects:

High-precision and three-phase unified modeling is achieved for a dynamic component of a power system. An MMoE-DAE model can achieve precise modeling of a complex high-order dynamic component in the power system even in the absence of a detailed physical model. A neural ordinary differential equation (ODE) and an automatic order upgrading mechanism are integrated, which effectively enhances a modeling capability for a dynamic behavior of a complex component under various disturbance scenarios, and ensures high precision and robustness even under a strong nonlinear and high-order dynamic condition. Unified modeling of a three-phase circuit allows for simultaneous processing of a dynamic characteristic of a circuit of each phase under a same framework, and processes a coupling relationship between phases through a multi-task learning mechanism, thereby significantly reducing an error caused by separate phase processing in a traditional modeling method and improving overall simulation efficiency.

A graph neural network (GNN) model is used to aggregate information of adjacent nodes, and better performance is achieved by integrating system topology information.

Model parameters, performance, and the like when a multi-dimensional data matrix and oscillating current time-series data are used as model inputs show that using the multi-dimensional data matrix as the model input not only has better timeliness but also achieves better positioning performance.

### BRIEF DESCRIPTION OF THE DRAWINGS

FIG. 1 shows an architecture of an MMoE-DAE network for three-phase circuit modeling of a dynamic component; and

FIG. 2 is a schematic diagram of an automatic order upgrading mechanism.

### DETAILED DESCRIPTION OF THE EMBODIMENTS

A method for dynamic modeling of a power system component based on an MMoE-DAE model is provided.

Firstly, the MMoE-DAE model is a data-driven multi-expert model that uses measured data (such as a voltage and a current) of a system port to infer a dynamic behavior of a component. Although there is no complete physical model, an input-output relationship of the component can be captured through a measurement signal, and reflects dynamic characteristics of the component under different operating conditions. Therefore, even if a physical model is incomplete, the MMoE-DAE model can still construct an equivalent dynamic model based on the measured data to achieve high-precision modeling of the dynamic characteristics of the component.

Secondly, in a modern power system, the dynamic behavior of the component is usually represented as a high-order nonlinear differential equation. This patent introduces an automatic order upgrading module, which can automatically identify a dynamic order of the component, thereby enhancing a simulation capability of a high-order dynamic behavior of the component.

Thirdly, the MMoE-DAE model can accurately simulate a dynamic relationship between the phases within a same model, to achieve unified modeling of the three-phase circuit and compensate for a shortcoming of a traditional model in processing a coupling relationship between the phases.

Fourthly, the MMoE-DAE model can be seamlessly integrated into an existing EMT simulation platform CloudPSS to ensure efficient real-time simulation and dynamic analysis in an actual industrial application, thereby enhancing practicality and reliability of EMT simulation in the power system.

Architecture of an MMoE-DAE network for three-phase circuit modeling of a dynamic component:

The MMoE-DAE network can effectively learn a dynamic characteristic of the component by combining a plurality of neural-ODE expert modules. A neural-ODE expert module regards states (such as a current and a voltage) of the system as time functions, and fits changing trends of these states to approximately represent differential changes of these states over time (that is, approximates traditional differential equations). This is equivalent to learning a differential equation approximate to actual dynamics of the system, such that a complex nonlinear system behavior can be approximated with high precision. Therefore, even without a detailed physical equation, an input-output relationship of the component can still be learned from data, and a dynamic equivalent model is established. After historical current and voltage signals of circuits of the phases are input, the MMoE-DAE model automatically selects a most suitable neural-ODE expert module through a gating network to process a current modeling task. That is, each expert module is assigned to a specific task and focuses on a given type of dynamic characteristic, thereby ensuring that the MMoE-DAE model can perform well in different scenarios. Therefore, the MMoE-DAE model not only can simulate a single component, but also can process different components or different dynamic characteristics simultaneously through a plurality of expert modules, to form a unified multi-task learning framework. In this way, even if some components have no complete physical models, the MMoE-DAE network can still learn complex dynamic behaviors of the components from limited port data by sharing an underlying neural network and achieving collaboration among different tasks.

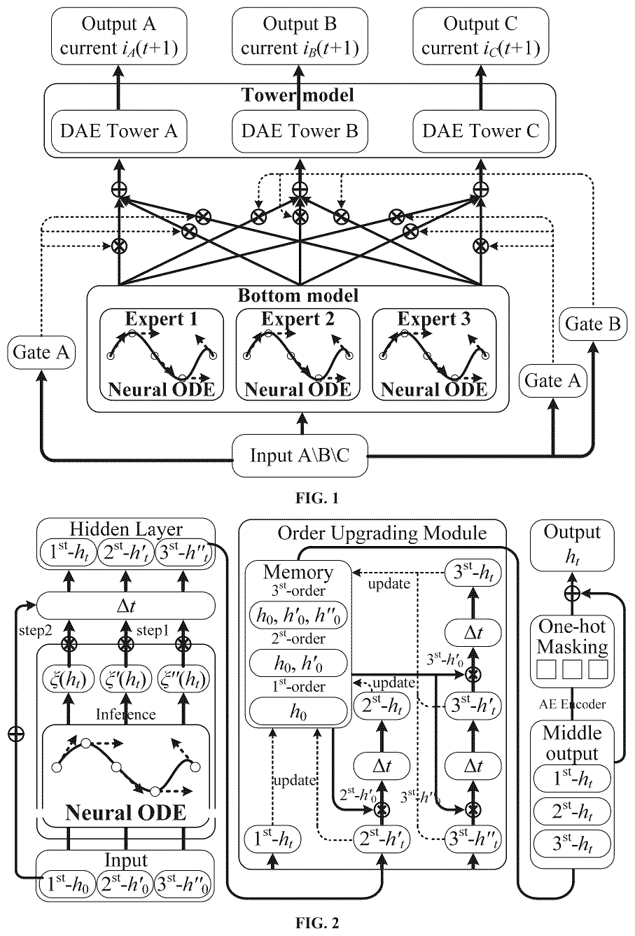

The architecture of the MMoE-DAE network for the three-phase circuit modeling of the dynamic component is shown in FIG. 1.

The architecture includes four parts: an input part, a bottom model (including the neural-ODE expert module), a tower model (DAE tower), and a gating network module. The input part receives the historical current signals i_{A}(t), i_{B}(t), i_{C}(t) of the circuits of the phases, the historical voltage signals u_{A}(t), u_{B}(t), u_{C}(t) of the circuits of the phases, and an external signal. These input signals are transmitted to an underlying neural-ODE expert module through the gating network to predict current and voltage changes at a next time step. The bottom model includes a plurality of neural-ODE expert modules. Each expert module is responsible for processing a different dynamic characteristic and scheduled by the gating network to determine which modules participate in the current modeling task. The neural-ODE expert module is configured to approximate a differential equation of the dynamic component and model a relationship between voltage and current changes of the circuits of the phases and time. The input signals i_{A}(t), i_{B}(t), i_{C}(t) are processed by a neural ODE to obtain currents i_{A}(t+1), i_{B}(t+1), i_{C}(t+1) of the circuits of the phases at the next time step. The gating network module is responsible for selecting and scheduling the expert modules, choosing an appropriate neural-ODE expert for the current modeling task based on characteristics of the input signals, performing weight allocation through a softmax function, and scheduling the neural-ODE expert to participate in the modeling. An output of the gating network module is transferred to a corresponding DAE tower based on states of the circuits of the phases. The tower model is divided into a plurality of DAE towers, and each DAE tower is configured to process a current of a corresponding phase in the three-phase circuit, that is i_{A}(t+1), i_{B}(t+1), i_{C}(t+1). Based on the DAE towers, the MMoE-DAE model can simultaneously process multi-task modeling of the three-phase circuit and establish an interrelationship between the currents of the phases.

### Automatic Order Upgrading Mechanism:

A traditional neural network model is usually difficult to capture a high-order dynamic behavior (such as high-frequency oscillation or a nonlinear disturbance). The automatic order upgrading mechanism introduced in this patent can automatically infer an optimal dynamic order of the component through a plurality of numerical integration channels, such that the neural-ODE expert can process the high-order dynamic behavior. With the automatic order upgrading mechanism, the MMoE-DAE model still can dynamically adjust a modeling order based on data for a complex component lacking detailed physical information, thereby ensuring modeling precision. Specifically, the automatic order upgrading module processes dynamic behaviors of different orders through a plurality of independent integration channels and automatically selects an optimal output through the gating network and a backward Euler method. This significantly improves modeling precision in a high-order dynamic system, especially suitable for a system that processes complex, nonlinear and multi-path coupling.

A multi-channel integration module has a plurality of independent integration channels, which are configured to process derivatives of different orders. Each channel performs numerical integration based on a previous state, thereby calculating a derivative value of a corresponding order. A first-order channel calculates a change rate of a system state, namely a derivative, to predict a change of the system state at the next time step. A second-order channel processes a first derivative and a second derivative, and calculates an acceleration or a higher-order change of the system through state space transformation. A third-order channel processes a higher-order change rate to capture a high-order dynamic behavior in a complex system. A state storage unit is further introduced in the automatic order upgrading module to store state information calculated by each channel, such that the system can access a previous state and derivative value when performing a plurality of integration operations, thereby guaranteeing continuity and accuracy of each channel.

The gating network is configured to select a best order output from outputs of the integration channels. A channel whose output is most appropriate is determined by using a trainable weight matrix W_{go} and the softmax function.

A principle of a multi-channel backward Euler upgrading module with dynamic component order identification is shown in FIG. 2:

An input initial state h₀, the first derivative h₀′, and the second derivative h₀″ undergo backward Euler upgrading to obtain first-order, second-order, and third-order predicted values. Specifically, the backward Euler method performs the numerical integration on a derivative of each order, thereby deriving a state change at each time step and ultimately obtaining a state at the next time step.

### Dynamic Simulation Interface:

The EMT simulation replaces each component with a Norton equivalent circuit, and constructs a network equation based on the equivalent circuit. This method avoids analyzing all DAEs of the system as discrete entities, thereby improving modeling efficiency. A component simulation interface performs following four steps:
(1) Calculate a state variable x(t+Δt).

The state variable x(t+Δt) is inferred based on measured values î(t), ù(t) and \hat{z}(t) of a component port. The x(t+Δt) is calculated by using a trapezoidal integration method:

$$x ( t + Δ t ) = x ( t ) + \frac{Δ t}{2} ( {ξ}_{ODE} ( x ( t ) ) + {ξ}_{ODE} ( x ( t + Δ t ) ) )$$

where a variable x(t) represents an implicit function of a port measurement value, which is constructed by an ODE expert neuron, namely x(t)=Γ(x(t−Δt),î(t),û(t),\hat{z}(t),t).
(2) Derive a Norton equivalent current i(t+Δt) of the component.

Following formulas are used:

$$\{ \begin{matrix}\dot{x} = f ( x , y , u ) \\ i = g ( x , y , u )\end{matrix}$$

As described above, i represents a component injection current, and g(⋅) represents an AE describing a component current. An AE tower module is used to calculate a port current of the dynamic component.

$$i ( t + Δ t ) = {Φ}_{ae} ( x ( t + Δ t ) , \hat{ι} ( t ) , \hat{u} ( t ) , \hat{z} ( t ) )$$

The steps (1) and (2) are executed entirely within the MMoE-DAE network, and a function of the MMoE-DAE network is consistent with an external characteristic of a general component.
(3) Calculate a voltage vector V(t+Δt): Combine a current I_{eql}(t+Δt) of a data-driven model component and a current I_{gen}(t+Δt) of the general component based on a node connection relationship to obtain that:

$$I ( t + Δ t ) = [ {I}_{eql} ( t + Δ t ) + {I}_{gen} ( t + Δ t ) ]$$

A combined current is substituted into GV=I to obtain that:

$$GV ( t + Δ t ) = I ( t + Δ t )$$

(4) Calculate a branch current Iᵢⱼ(t+Δt): Calculate the Iᵢⱼ(t+Δt) based on the V(t+Δt) and corresponding admittance Gᵢⱼ, in order to complete a historical current iteration process for the general component:

$${I}_{ij} ( t + Δ t ) = {G}_{ij} ( {V}_{i} ( t + Δ t ) - {V}_{j} ( t + Δ t ) ) .$$

### Application

### 1) Data Preparation and Processing

Data collection: A simulation example is established, a topology of the example is obtained, a location disturbance source is set in the example, and time-series operation data and a disturbance source location label of a current of each line during a system failure are collected.
Signal processing: Preprocessing such as extraction of a discrete component, filtering, and denoising is performed on a collected time-series signal to enhance accuracy and efficiency of model training. Subsequently, a preprocessed decaying direct current (DC) component is extracted, and Taylor expansion is performed. The derivative of each order is extracted to construct a model input matrix.

### (2) Model Design and Training

Model architecture design: A GNN model architecture is designed, and a wideband oscillation disturbance source positioning model is constructed.
Model training: The MMoE-DAE model is trained by using a prepared dataset, and model parameters are adjusted to optimize performance.
Verification and testing: The MMoE-DAE model is verified and tested to evaluate its performance in positioning a wideband oscillation disturbance source.

### (3) Online Application and Real-Time Performance

Model deployment: A trained MMoE-DAE model is deployed on an actual power system monitoring platform.
Real-time performance optimization: A strategy is studied and implemented to enhance disturbance source positioning performance of the MMoE-DAE model, including reducing a latency, improving an accuracy rate, increasing a response speed, and the like.
Continuous learning: An implementation mechanism enables the MMoE-DAE model to be continuously updated and optimized based on newly collected data, thereby enhancing generalization of the MMoE-DAE model.

### (4) Evaluation and Iteration

Performance evaluation: Positioning performance of the MMoE-DAE model is comprehensively evaluated, and a confusion matrix for evaluating performance of the MMoE-DAE model is established.
Iterative optimization: Based on a performance evaluation result of the MMoE-DAE model, the MMoE-DAE model is iteratively optimized to enhance its stability and reliability.
Conclusion: High-precision and three-phase unified modeling is achieved for the dynamic component of the power system. The MMoE-DAE model can achieve precise modeling of a complex high-order dynamic component in the power system even in the absence of a detailed physical model. The neural ODE and the automatic order upgrading mechanism are integrated, which effectively enhances a modeling capability for a dynamic behavior of the complex component under various disturbance scenarios, and ensures high precision and robustness even under a strong nonlinear and high-order dynamic condition. The unified modeling of the three-phase circuit allows for simultaneous processing of dynamic characteristics of the circuits of the phases under a same framework, and processes a coupling relationship between the phases through a multi-task learning mechanism, thereby significantly reducing an error caused by separate phase processing in a traditional modeling method and improving overall simulation efficiency.

A GNN model is used to aggregate information of adjacent nodes, and better performance is achieved by integrating system topology information.

| Index | GNN | CNN | DNN | DT |
|---|---|---|---|---|
| Accuracy rate | 97.2% | 93.1% | 92.7% | 74.6% |
| Error rate | 0.97% | 3.65% | 4.01% | 12.74% |
| Classification | 0.07 | 0.15 | 0.13 | 0.57 |
| error | | | | |

Model parameters, performance, and the like when a multi-dimensional data matrix and oscillating current time-series data are used as model inputs show that using the multi-dimensional data matrix as the model input not only has better timeliness but also achieves better positioning performance.

| | Multi-dimensional | Oscillating current |
|---|---|---|
| Index | data matrix | time-series data |
| Parameters | 27378 | 711828 |
| Reasoning speed | 2.429 ms | 4.318 ms |
| Accuracy rate | 97.2% | 96.8% |

What is claimed is:

1. A method for dynamic modeling of a power system component based on a multi-gate mixture-of-experts (MMoE)-differential-algebraic equation (DAE) model, comprising following steps:
S1: proposing an MMoE-DAE network, simulating a dynamic characteristic of a three-phase circuit by using a plurality of gated neural DAEs, and establishing a relationship between phases;
S2: proposing an automatic order upgrading module, and adopting a plurality of independent continuous numerical integration channels and a relevant state variable memory to automatically infer an optimal order for dynamic component modeling through a fully gated network; and
S3: accurately simulating, by the MMoE-DAE model, a dynamic relationship between the phases within a same model, to achieve unified modeling of the three-phase circuit and compensate for a shortcoming of a traditional model in processing a coupling relationship between the phases; and seamlessly integrating the MMoE-DAE model into an electromagnetic transient (EMT) simulation platform, and enabling real-time simulation and dynamic analysis in a practical industrial application scenario, thereby enhancing practicality and reliability of EMT simulation in a power system.

2. The method for dynamic modeling of a power system component based on an MMoE-DAE model according to claim 1, wherein in the step S1:
an architecture of the MMoE-DAE network for three-phase circuit modeling of a dynamic component comprises four parts: an input part, a bottom model, a tower model, and a gating network module;
the input part receives historical current signals i_{A}(t), i_{B}(t), i_{C}(t) of circuits of the phases, historical voltage signals u_{A}(t), u_{B}(t), u_{C}(t) of the circuits of the phases, and an external signal; and the historical current signals, the historical voltage signals, and the external signal are transmitted to an underlying neural-ordinary differential equation (ODE) expert module through a gating network to predict current and voltage changes at a next time step;
the bottom model comprises a plurality of neural-ODE expert modules, wherein each of the plurality of neural-ODE expert modules is responsible for processing a different dynamic characteristic and scheduled by the gating network to determine which modules participate in a current modeling task; the plurality of neural-ODE expert modules are configured to approximate a differential equation of the dynamic component and model a relationship between current and voltage changes of the circuits of the phases and time; and the input signals i_{A}(t), i_{B}(t), i_{C}(t) are processed by a neural ODE to obtain currents i_{A}(t+1), i_{B}(t+1), i_{C}(t+1) of the circuits of the phases at the next time step;
the gating network module is responsible for selecting and scheduling the plurality of neural-ODE expert modules, choosing an appropriate neural-ODE expert for the current modeling task based on characteristics of the input signals, performing weight allocation through a softmax function, and scheduling the neural-ODE expert to participate in the modeling, wherein an output of the gating network module is transferred to a corresponding DAE tower based on states of the circuits of the phases; and
the tower model is divided into a plurality of DAE towers, and each of the plurality of DAE towers is configured to process a current of a corresponding phase in the three-phase circuit, namely the i_{A}(t+1), i_{B}(t+1), i_{C}(t+1); and based on the plurality of DAE towers, the MMoE-DAE model is capable of simultaneously processing multi-task modeling of the three-phase circuit and establishing an interrelationship between currents of the phases.

3. The method for dynamic modeling of a power system component based on an MMoE-DAE model according to claim 2, wherein in the step S2, the automatic order upgrading module is configured to:
automatically infer an optimal dynamic order of a component through the plurality of independent continuous numerical integration channels to enable the neural-ODE expert to process a high-order dynamic behavior, such that the MMoE-DAE model is still capable of dynamically adjusting a modeling order based on data for a component lacking detailed physical information, thereby ensuring modeling precision;
the automatic order upgrading module processes dynamic behaviors of different orders through the plurality of independent continuous numerical integration channels and automatically selects an optimal output through the gating network and a backward Euler method;
a multi-channel integration module has a plurality of independent integration channels, wherein each of the plurality of independent integration channels is configured to process a derivative of an order, and performs numerical integration based on a previous state to calculate a derivative value of the order; a first-order channel calculates a change rate of a system state, namely a derivative, to predict a change of the system state at the next time step; a second-order channel processes a first derivative and a second derivative, and calculates an acceleration or a higher-order change of the power system through state space transformation; and a third-order channel processes a higher-order change rate to capture a high-order dynamic behavior in a complex system;
a state storage unit is further introduced in the automatic order upgrading module to store state information calculated by each of the plurality of independent continuous numerical integration channels, such that the system is capable of accessing a previous state and derivative value when performing a plurality of integration operations, thereby guaranteeing continuity and accuracy of each of the plurality of independent continuous numerical integration channels; and
the gating network is configured to select a best order output from outputs of the plurality of independent continuous numerical integration channels, and a channel whose output is most appropriate is determined by using a trainable weight matrix W_{go} and the softmax function; wherein
a principle of a multi-channel backward Euler upgrading module with dynamic component order identification is as follows:
an input initial state h₀, the first derivative h₀′, and the second derivative h₀″ undergo backward Euler upgrading to obtain first-order, second-order, and third-order predicted values;
and the backward Euler method performs numerical integration on a derivative of each order, thereby deriving a state change at each time step and ultimately obtaining a state at the next time step.

4. The method for dynamic modeling of a power system component based on an MMoE-DAE model according to claim 3, wherein the step S3 is as follows:
replacing, by the EMT simulation, each component with a Norton equivalent circuit, and constructing a network equation based on the equivalent circuit, thereby avoiding analyzing all DAEs of the system as discrete entities; and
a component simulation interface performs following four steps:
(1) calculating a state variable x(t+Δt)
inferring the state variable x(t+Δt) based on measured values î(t), û(t), and \hat{z}(t) of a component port, and calculating the x(t+Δt) by using a trapezoidal integration method:
$$x ( t + Δ t ) = x ( t ) + \frac{Δ t}{2} ( {ξ}_{ODE} ( x ( t ) ) + {ξ}_{ODE} ( x ( t + Δ t ) ) )$$
wherein a variable x(t) represents an implicit function of a port measurement value, which is constructed by an ODE expert neuron, namely x(t)=Γ(x(t−Δt),î(t),û(t),\hat{z}(t),t);
(2) deriving a Norton equivalent current i(t+Δt) of the component
wherein following formulas are used:
$$\{ \begin{matrix}\dot{x} = f ( x , y , u ) \\ i = g ( x , y , u )\end{matrix}$$
wherein i represents a component injection current, and g(⋅) represents an algebraic equation (AE) describing a component current; and an AE tower module is used to calculate a port current of the dynamic component:
$$i ( t + Δ t ) = {Φ}_{ae} ( x ( t + Δ t ) , \hat{ι} ( t ) , \hat{u} ( t ) , \hat{z} ( t ) )$$
the steps (1) and (2) are executed entirely within the MMoE-DAE network, and a function of the MMoE-DAE network is consistent with an external characteristic of a general component;
(3) calculating a voltage vector V(t+Δt): combining a current I_{egl}(t+Δt) of a data-driven model component and a current I_{gen}(t+Δt) of the general component based on a node connection relationship to obtain that:
$$I ( t + Δ t ) = [ {I}_{e q l} ( t + Δ t ) + {I}_{g e n} ( t + Δ t ) ]$$
substituting a combined current into a formula GV=I to obtain that:
$$G V ( t + Δ t ) = I ( t + Δ t )$$
(4) calculating a branch current Iᵢⱼ(t+Δt): calculating the Iᵢⱼ(t+Δt) based on the V(t+Δt) and corresponding admittance Gᵢⱼ, in order to complete a historical current iteration process for the general component:
$${I}_{ij} ( t + Δ t ) = {G}_{ij} ( {V}_{i} ( t + Δ t ) - {V}_{j} ( t + Δ t ) ) .$$

5. A system for dynamic modeling of a power system component based on an MMoE-DAE model, wherein the method for dynamic modeling of a power system component based on an MMoE-DAE model according to claim 1 is used to perform dynamic modeling for the power system component.

6. A non-transitory storage medium, wherein the non-transitory storage medium stores a computer program, and the computer program is executed to implement the method for dynamic modeling of a power system component based on an MMoE-DAE model according to claim 1.

7. The system for dynamic modeling of a power system component based on an MMoE-DAE model according to claim 5, wherein in the step S1:
an architecture of the MMoE-DAE network for three-phase circuit modeling of a dynamic component comprises four parts: an input part, a bottom model, a tower model, and a gating network module;
the input part receives historical current signals i_{A}(t), i_{B}(t), i_{C}(t) of circuits of the phases, historical voltage signals u_{A}(t), u_{B}(t), u_{C}(t) of the circuits of the phases, and an external signal;
and the historical current signals, the historical voltage signals, and the external signal are transmitted to an underlying neural-ordinary differential equation (ODE) expert module through a gating network to predict current and voltage changes at a next time step;
the bottom model comprises a plurality of neural-ODE expert modules, wherein each of the plurality of neural-ODE expert modules is responsible for processing a different dynamic characteristic and scheduled by the gating network to determine which modules participate in a current modeling task; the plurality of neural-ODE expert modules are configured to approximate a differential equation of the dynamic component and model a relationship between current and voltage changes of the circuits of the phases and time; and the input signals i_{A}(t), i_{B}(t), i_{C}(t) are processed by a neural ODE to obtain currents i_{A}(t+1), i_{B}(t+1), i_{C}(t+1) of the circuits of the phases at the next time step;
the gating network module is responsible for selecting and scheduling the plurality of neural-ODE expert modules, choosing an appropriate neural-ODE expert for the current modeling task based on characteristics of the input signals, performing weight allocation through a softmax function, and scheduling the neural-ODE expert to participate in the modeling, wherein an output of the gating network module is transferred to a corresponding DAE tower based on states of the circuits of the phases; and
the tower model is divided into a plurality of DAE towers, and each of the plurality of DAE towers is configured to process a current of a corresponding phase in the three-phase circuit, namely the i_{A}(t+1), i_{B}(t+1), i_{C}(t+1); and based on the plurality of DAE towers, the MMOE-DAE model is capable of simultaneously processing multi-task modeling of the three-phase circuit and establishing an interrelationship between currents of the phases.

8. The system for dynamic modeling of a power system component based on an MMoE-DAE model according to claim 7, wherein in the step S2, the automatic order upgrading module is configured to:
automatically infer an optimal dynamic order of a component through the plurality of independent continuous numerical integration channels to enable the neural-ODE expert to process a high-order dynamic behavior, such that the MMoE-DAE model is still capable of dynamically adjusting a modeling order based on data for a component lacking detailed physical information, thereby ensuring modeling precision;
the automatic order upgrading module processes dynamic behaviors of different orders through the plurality of independent continuous numerical integration channels and automatically selects an optimal output through the gating network and a backward Euler method;
a multi-channel integration module has a plurality of independent integration channels, wherein each of the plurality of independent integration channels is configured to process a derivative of an order, and performs numerical integration based on a previous state to calculate a derivative value of the order; a first-order channel calculates a change rate of a system state, namely a derivative, to predict a change of the system state at the next time step; a second-order channel processes a first derivative and a second derivative, and calculates an acceleration or a higher-order change of the power system through state space transformation; and a third-order channel processes a higher-order change rate to capture a high-order dynamic behavior in a complex system;
a state storage unit is further introduced in the automatic order upgrading module to store state information calculated by each of the plurality of independent continuous numerical integration channels, such that the system is capable of accessing a previous state and derivative value when performing a plurality of integration operations, thereby guaranteeing continuity and accuracy of each of the plurality of independent continuous numerical integration channels; and
the gating network is configured to select a best order output from outputs of the plurality of independent continuous numerical integration channels, and a channel whose output is most appropriate is determined by using a trainable weight matrix W_{go} and the softmax function;
wherein a principle of a multi-channel backward Euler upgrading module with dynamic component order identification is as follows:
an input initial state h₀, the first derivative h₀′, and the second derivative h₀″ undergo backward Euler upgrading to obtain first-order, second-order, and third-order predicted values;
and the backward Euler method performs numerical integration on a derivative of each order, thereby deriving a state change at each time step and ultimately obtaining a state at the next time step.

9. The system for dynamic modeling of a power system component based on an MMoE-DAE model according to claim 8, wherein the step S3 is as follows:
replacing, by the EMT simulation, each component with a Norton equivalent circuit, and constructing a network equation based on the equivalent circuit, thereby avoiding analyzing all DAEs of the system as discrete entities; and
a component simulation interface performs following four steps:
(1) calculating a state variable x(t+Δt)
inferring the state variable x(t+Δt) based on measured values î(t), û(t), and \hat{z}(t) of a component port, and calculating the x(t+Δt) by using a trapezoidal integration method:
$$x ( t + Δ t ) = x ( t ) + \frac{Δ t}{2} ( {ξ}_{ODE} ( x ( t ) ) + {ξ}_{ODE} ( x ( t + Δ t ) ) )$$
wherein a variable x(t) represents an implicit function of a port measurement value, which is constructed by an ODE expert neuron, namely x(t)=Γ(x(t−Δt),î(t),û(t),\hat{z}(t),t);
(2) deriving a Norton equivalent current i(t+Δt) of the component
wherein following formulas are used:
$$\{ \begin{matrix}\dot{x} = f ( x , y , u ) \\ i = g ( x , y , u )\end{matrix}$$
wherein i represents a component injection current, and g(⋅) represents an algebraic equation (AE) describing a component current; and an AE tower module is used to calculate a port current of the dynamic component:
$$i ( t + Δ t ) = {Φ}_{a e} ( x ( t + Δ t ) , î ( t ) , û ( t ) , \hat{z} ( t ) )$$
the steps (1) and (2) are executed entirely within the MMoE-DAE network, and a function of the MMoE-DAE network is consistent with an external characteristic of a general component;
(3) calculating a voltage vector V(t+Δt): combining a current I_{egl}(t+Δt) of a data-driven model component and a current I_{gen}(t+Δt) of the general component based on a node connection relationship to obtain that:
$$I ( t + Δ t ) = [ {I}_{e q l} ( t + Δ t ) + {I}_{g e n} ( t + Δ t ) ]$$
substituting a combined current into a formula GV=I to obtain that:
$$G V ( t + Δ t ) = I ( t + Δ t )$$
(4) calculating a branch current Iᵢⱼ(t+Δt): calculating the Iᵢⱼ(t+Δt) based on the V(t+Δt) and corresponding admittance Gᵢⱼ, in order to complete a historical current iteration process for the general component:
$${I}_{ij} ( t + Δ t ) = {G}_{ij} ( {V}_{i} ( t + Δ t ) - {V}_{j} ( t + Δ t ) ) .$$

10. The non-transitory storage medium according to claim 6, wherein in the step S1:
an architecture of the MMoE-DAE network for three-phase circuit modeling of a dynamic component comprises four parts: an input part, a bottom model, a tower model, and a gating network module;
the input part receives historical current signals i_{A}(t), i_{B}(t), i_{C}(t) of circuits of the phases, historical voltage signals u_{A}(t), u_{B}(t), u_{C}(t) of the circuits of the phases, and an external signal; and the historical current signals, the historical voltage signals, and the external signal are transmitted to an underlying neural-ordinary differential equation (ODE) expert module through a gating network to predict current and voltage changes at a next time step;
the bottom model comprises a plurality of neural-ODE expert modules, wherein each of the plurality of neural-ODE expert modules is responsible for processing a different dynamic characteristic and scheduled by the gating network to determine which modules participate in a current modeling task; the plurality of neural-ODE expert modules are configured to approximate a differential equation of the dynamic component and model a relationship between current and voltage changes of the circuits of the phases and time; and the input signals i_{A}(t), i_{B}(t), i_{C}(t) are processed by a neural ODE to obtain currents i_{A}(t+1), i_{B}(t+1), i_{C}(t+1) of the circuits of the phases at the next time step;
the gating network module is responsible for selecting and scheduling the plurality of neural-ODE expert modules, choosing an appropriate neural-ODE expert for the current modeling task based on characteristics of the input signals, performing weight allocation through a softmax function, and scheduling the neural-ODE expert to participate in the modeling, wherein an output of the gating network module is transferred to a corresponding DAE tower based on states of the circuits of the phases; and
the tower model is divided into a plurality of DAE towers, and each of the plurality of DAE towers is configured to process a current of a corresponding phase in the three-phase circuit, namely the i_{A}(t+1), i_{B}(t+1), i_{C}(t+1); and based on the plurality of DAE towers, the MMoE-DAE model is capable of simultaneously processing multi-task modeling of the three-phase circuit and establishing an interrelationship between currents of the phases.

11. The non-transitory storage medium according to claim 10, wherein in the step S2, the automatic order upgrading module is configured to:
automatically infer an optimal dynamic order of a component through the plurality of independent continuous numerical integration channels to enable the neural-ODE expert to process a high-order dynamic behavior, such that the MMoE-DAE model is still capable of dynamically adjusting a modeling order based on data for a component lacking detailed physical information, thereby ensuring modeling precision;
the automatic order upgrading module processes dynamic behaviors of different orders through the plurality of independent continuous numerical integration channels and automatically selects an optimal output through the gating network and a backward Euler method;
a multi-channel integration module has a plurality of independent integration channels, wherein each of the plurality of independent integration channels is configured to process a derivative of an order, and performs numerical integration based on a previous state to calculate a derivative value of the order; a first-order channel calculates a change rate of a system state, namely a derivative, to predict a change of the system state at the next time step; a second-order channel processes a first derivative and a second derivative, and calculates an acceleration or a higher-order change of the power system through state space transformation; and a third-order channel processes a higher-order change rate to capture a high-order dynamic behavior in a complex system;
a state storage unit is further introduced in the automatic order upgrading module to store state information calculated by each of the plurality of independent continuous numerical integration channels, such that the system is capable of accessing a previous state and derivative value when performing a plurality of integration operations, thereby guaranteeing continuity and accuracy of each of the plurality of independent continuous numerical integration channels; and
the gating network is configured to select a best order output from outputs of the plurality of independent continuous numerical integration channels, and a channel whose output is most appropriate is determined by using a trainable weight matrix W_{go} and the softmax function; wherein
a principle of a multi-channel backward Euler upgrading module with dynamic component order identification is as follows:
an input initial state h₀, the first derivative h₀′, and the second derivative h₀″ undergo backward Euler upgrading to obtain first-order, second-order, and third-order predicted values;
and the backward Euler method performs numerical integration on a derivative of each order, thereby deriving a state change at each time step and ultimately obtaining a state at the next time step.

12. The non-transitory storage medium according to claim 11, wherein the step S3 is as follows:
replacing, by the EMT simulation, each component with a Norton equivalent circuit, and constructing a network equation based on the equivalent circuit, thereby avoiding analyzing all DAEs of the system as discrete entities; and
a component simulation interface performs following four steps:
(1) calculating a state variable x(t+Δt)
inferring the state variable x(t+Δt) based on measured values î(t), û(t), and \hat{z}(t) of a component port, and calculating the x(t+Δt) by using a trapezoidal integration method:
$$x ( t + Δ t ) = x ( t ) + \frac{Δ t}{2} ( {ξ}_{ODE} ( x ( t ) ) + {ξ}_{ODE} ( x ( t + Δ t ) ) )$$
wherein a variable x(t) represents an implicit function of a port measurement value, which is constructed by an ODE expert neuron, namely x(t)=Γ(x(t−Δt),î(t),û(t),\hat{z}(t),t);
(2) deriving a Norton equivalent current i(t+Δt) of the component
wherein following formulas are used:
$$\{ \begin{matrix}\dot{x} = f ( x , y , u ) \\ i = g ( x , y , u )\end{matrix}$$
wherein i represents a component injection current, and g(⋅) represents an algebraic equation (AE) describing a component current; and an AE tower module is used to calculate a port current of the dynamic component:
$$i ( t + Δ t ) = {Φ}_{a e} ( x ( t + Δ t ) , î ( t ) , û ( t ) , \hat{z} ( t ) )$$
the steps (1) and (2) are executed entirely within the MMoE-DAE network, and a function of the MMoE-DAE network is consistent with an external characteristic of a general component;
(3) calculating a voltage vector V(t+Δt): combining a current I_{egl}(t+Δt) of a data-driven model component and a current I_{gen}(t+Δt) of the general component based on a node connection relationship to obtain that:
$$I ( t + Δ t ) = [ {I}_{e q l} ( t + Δ t ) + {I}_{g e n} ( t + Δ t ) ]$$
substituting a combined current into a formula GV=I to obtain that:
$$G V ( t + Δ t ) = I ( t + Δ t )$$
(4) calculating a branch current Iᵢⱼ(t+Δt): calculating the Iᵢⱼ(t+Δt) based on the V(t+Δt) and corresponding admittance Gᵢⱼ, in order to complete a historical current iteration process for the general component:
$${I}_{ij} ( t + Δ t ) = {G}_{ij} ( {V}_{i} ( t + Δ t ) - {V}_{j} ( t + Δ t ) ) .$$
